(19) United States
(12) Patent Application Publication
(10) Pub. No.: US 2010/0143568 A1
(43) Pub. Date: Jun. 10, 2010

(54) SPREADABLE FOOD PRODUCT AND A MANUFACTURING PROCESS THEREFOR

(75) Inventors: Ken Quail, New South Wales (AU); Hon Yun, New South Wales (AU); Gasiram Rema, New South Wales (AU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Grain Foods CRC Ltd, New South Wales (AU)

(21) Appl. No.: 12/374,278

(22) PCT Filed: Jul. 19, 2007
(86) PCT No.: PCT/AU2007/001007

§ 371 Date: Dec. 7, 2009

(30) Foreign Application Priority Data
Jul. 19, 2006 (AU) 2006903884

(51) Int. Cl. A23L 1/20

(52) U.S. Cl. 426/615; 426/518

(57) ABSTRACT

Processes for producing a spreadable food product which has a nut-like taste but is allergen-free or has low-allergenicity are provided. The processes includes the steps of grinding a plant material to produce a flour with a mean particle size of less than 100 m and subjecting the flour to an elevated temperature. Typically, the plant material is a non-nut plant material. Also provided are compositions for a spreadable food product produced according to the processes of the invention. A particular application of this process is a spreadable food product which is suitable for consumption by individuals with allergies and in particular, nut allergies.

### FIELD OF THE INVENTION

The present invention relates to a spreadable food product. In particular, this invention relates to a process for the production of a nut-free spread.

### BACKGROUND OF THE INVENTION

Peanut butter and other nut-based spreads are immensely popular processed food products. Typically, whole peanuts are roasted and ground to form the basis of peanut butter. However, it is estimated that 0.5% of the population have an allergy to peanuts. A reaction to peanut allergen can range from mild to life-threatening anaphylactic reactions. Moreover, peanut-based spreads contain high levels of fat and thus not nutritionally desirable.

Due to the prevalence of peanut allergy, a need exists in the market to provide processed food products that are safe for consumption by peanut allergy sufferers. Considering this need, peanut butter like nut-free spreadable food products are not yet widely available. This dearth can be attributed to the difficulty in producing a nut-free product with peanut butter like characteristics. Trials of nut-free spreads in Canada, the USA and Europe have demonstrated that these products differ from peanut-based spreads in terms of texture, appearance and flavour. Several attempts have been made to alleviate these problems, all of which have been met with limited success.

### SUMMARY OF THE INVENTION

There exists a need in the market to provide food products which are safe for consumption for people with an allergy to food allergens such as peanut allergens. The present is broadly directed to a unique combination of processing steps which provides a nut-free spreadable food product with the characteristic nutty taste of conventional peanut butter-based spreads but with a lower fat content.

In a first aspect, the invention provides a process of producing a spreadable food product, which includes the steps of
(a) grinding a non-nut plant material to produce a flour with a mean particle size of less than about 100 μm and;
(b) subjecting said flour to an elevated temperature.

In a second aspect, the invention provides a process for producing a spreadable food product which includes the steps of
(a) subjecting a non-nut plant material to an elevated temperature and;
(b) grinding said non-nut plant material to produce a flour with a mean particle size of less than about 100 μm.

In a third aspect, the invention provides a process for producing a spreadable food product which includes the steps of
(a) steaming dehulled, non-nut plant material; and
(b) grinding said non-nut plant material to produce a flour with a mean particle size of less than about 100 μm.

According to this aspect, grinding occurs at a temperature of at least 45° C. Preferably, grinding is performed at a temperature of least 60° C.

Suitably, the grinding step in any one of the previous aspects includes a sifting step in order to achieve a flour with a mean particle size of less than about 100 μm.

Preferably, the flour has a mean particle size of between 40 μm and 85 μm.

More preferably, the flour has a mean particle size of about 50 μm.

The invention is broadly directed to a spreadable food product with the particular feature of being suitable for consumption by people with food allergies, and, in particular, nut allergies. Hence use of a plant material as the basis of the spreadable food product which either is allergen-free or has low-allergenicity is desirable. Suitably, the plant material is a non-nut plant material which includes, but is not limited to, a cereal grain and a legume.

Preferably, the cereal grain is rice.

This invention is particularly suited for processing of a non-nut plant material derived from a legume. Most classes of legume are appropriate such as, but not limited to, beans, broad beans, peas, lentils or lupins.

Preferably, the legume is not a peanut or any other nut.

In certain preferred embodiments, the legume is a bean. According to these preferred embodiments, the bean is a mungbean.

According to other preferred embodiments, the legume is a pea. More preferably, the pea is a chickpea.

The elevated temperature is critical for achieving the desired nutty flavour. By way of example only, the elevated temperature can be achieved by either roasting or steaming.

Preferably, the roasting temperature is between 180° C. and 250° C.

More preferably, the roasting temperature is about 200° C.

The duration of roasting is a further crucial factor for developing the required nut-like flavour. The roasting time can range between 3 and 6 minutes.

Preferably, the roasting time is 3.5 to 4 minutes.

The degree of steaming is critical to neutralise the flavour of the beans that allows later manipulation of the overall flavour of the spread.

Preferably, the steaming temperature is between 80° C. and 150° C.

More preferably, the steaming temperature is about 100° C.

The steaming time can range from between 20 and 45 minutes.

Preferably, the steaming time is about 35 minutes.

In a preferred embodiment, the invention of the first and second aspect provides for a nutritionally improved spreadable food product by including the step of germinating the non-nut leguminous plant material prior to production of the flour. Germination can be induced by wetting the crop kernel followed by incubation under controlled conditions.

Preferably, germination is performed under light-deprived conditions for a suitable period between 12 to 48 hours.

More preferably, germination is performed for about 24 hours. Suitably, germination is performed at room temperature.

In a fourth aspect, the invention provides a spreadable food product produced using the method of any one of the previous aspects.

In a fifth aspect, the invention provides a spreadable food product comprising a non-nut plant material flour with a mean particle size of less than about 100 μm.

Preferably, the spreadable food product of the fourth aspect further comprises an edible oil and a sweetening agent.

More preferably, the spreadable food product of the fourth aspect further comprises an additive and a salt.

In a one preferred embodiment, the composition of the third aspect comprises 50-65% w/w of a flour, 25-35% w/w of an edible oil, 0-10% w/w of a sweetening agent, 0.2-0.5% w/w of salt and 3-3.5% w/w of an emulsifier.

Preferably, the flour is a mungbean flour. Suitably, the mungbean flour is at about 56.75% w/w.

The edible oil can be from either plant or animal origin. Suitably, the edible oil is a plant oil including, but limited to, vegetable oil, soybean oil, sunflower oil and canola oil.

Preferably, the plant oil is canola oil. Suitably, the canola oil is at about 35% w/w.

More preferably, the canola oil is unsaturated.

The sweetening agent may be added as a solution or a solid. Preferably, the sweetening agent is a solid. Suitably, the sweetening agent is added to a final concentration of about 5% w/w.

More preferably, the particle size of the solid sweetening agent is less than 90 μm.

Polyglycerol is a suitable emulsifier. Suitably, polyglycerol is added to a final concentration of about 3% w/w.

In another preferred embodiment, the composition of the third aspect comprises 30-40% w/w of a flour, 18-25% w/w of an edible oil, 10-15% w/w of a sweetening agent, 0.2-0.5% w/w of salt, 3-3.5% w/w of an emulsifier, 10-35% w/w of a chocolate flavouring.

Preferably, said flour is mungbean flour. Suitably, the mungbean flour is at about 33% w/w.

Preferably, said edible oil is canola oil at about 23% w/w.

More preferably, the canola oil is unsaturated.

Polyglycerol is a suitable emulsifier. Suitably, polyglycerol is added to a final concentration of about 3.25% w/w.

The sweetening agent may be added as a solution or a solid. Preferably, the sweetening agent is a solid. Suitably, the sweetening agent is added to a final concentration of about 13% w/w.

So as to produce the chocolate nut-free spread of this embodiment, it can be appreciated that most types of chocolate can be included in the composition as a chocolate flavouring. Non-limiting examples include milk and dark chocolate.

Preferably, said chocolate is dark chocolate. Suitably, the dark chocolate is added to a final concentration of about 27.52% w/w.

The chocolate may be added in combination with cocoa powder. Preferably, the chocolate flavouring of this embodiment is combination is 10% dark chocolate and 10% cocoa powder.

### BRIEF DESCRIPTION OF THE FIGURES

In order that the invention may be readily understood and put into practical effect, preferred embodiments will now be described by way of example with reference to the accompanying figures wherein like reference numerals refer to like parts and wherein:

FIG. 1 Organoleptic test result of 6 mungbean varieties.

FIG. 2 Objective measurement of the roasted mungbean powder (Roasting temperature: 200° C.). A. Flour yellowness Minolta b* and B. Flour brightness Minolta L*.

### DETAILED DESCRIPTION OF THE INVENTION

The process of the present invention overcomes several major disadvantages of conventional approaches for the production of nut-free spreadable food products. Foremost is production of a flour appropriate for use as a nut substitute in a spreadable food product. Furthermore, the composition of the present invention is a spreadable food product with a nut-like taste which is free of peanuts and thereby safe for consumption by people with peanut allergy. The spreadable food product has the added benefit of a smooth texture.

As nuts cannot form the basis of nut-free spreads, an alternative source must be used. Commonly, a plant material forms the substantial component of peanut butter-like or nut-like spreadable food products. In the absence of peanuts or nuts, the plant material is the component upon which the desired nutty flavour is developed. Thus the invention is particularly suited to processes for the manufacture of a spreadable food product which utilise a non-nut plant material.

In those embodiments where it is desirable to produce an allergen-free spreadable food product, the invention contemplates the use of a non-nut plant material derived from a source which is considered devoid of food allergens. A person of skill in the art will readily appreciate that in particular embodiments where the spreadable food product is allergen-free, a particularly suitable plant material for an allergen-free spreadable food product is a cereal grain, and in preferred embodiments, the cereal grain is rice.

The spreadable food product of the present invention is particularly suited to a leguminous plant material that is not a nut and in particular, a legume that is not a peanut. Non-limiting examples of suitable non-nut leguminous plant materials include beans, broad beans, peas, lentils and beans.

Preferably, the non-nut leguminous plant material is a mungbean.

More preferably, the mungbean is a variety selected from of the group consisting of Berken, Celera, Delta, Emerald, Green Diamond and White Gold.

Most preferably, the mungbean variety is Emerald.

In other preferred embodiments, the non-nut leguminous plant material is a pea such as, but not limited to, a chickpea.

Thus in one broad form, the invention contemplates an allergen-free spreadable food product derived from a non-nut plant material such as a cereal grain, but is not limited thereto.

In another broad form, the invention contemplates a low-allergenic spreadable food product derived from a non-nut plant material. It is readily contemplated that this broad form encompasses a non-nut leguminous plant material. In a preferred embodiment of this form, the non-nut leguminous plant material is a non-peanut leguminous plant material.

Subjecting the flour or the non-nut plant material to an elevated temperature is the primary means by which the desired nutty flavour is produced. The parameters can be varied depending upon the colour and flavour requirement. The step of subjecting the flour or the non-nut leguminous plant material to an elevated temperature can be performed either in batch or in a continuous system. Advantageously, this step is performed in batch.

The combination of temperature and duration is paramount to achieve the nut-like characteristics in a nut-free spread. The processes of the invention contemplate that either roasting or steaming is suitable for this purpose.

Preferably, the temperature for roasting is between 180° C. and 230° C. More preferably, the temperature for roasting is 200° C.

The duration of roasting can vary between 3 and 6 minutes. Preferably, the duration of roasting is between 3.5 to 4 minutes.

Typically, steaming is conducted at ambient pressure using saturated steam.

Preferably, the steaming temperature is between 80° C. and 150° C.

More preferably, the steaming temperature is about 100° C.

The steaming time can range from between 20 and 45 minutes.

Preferably, the steaming time is about 35 minutes.

It will be appreciated that in certain embodiments that incorporate cereal grain, and in particular rice, as the non-nut plant material, the steaming time can range from between 5 and 45 minutes. In a preferred embodiment, the steaming time for rice can range between 7 and 15 minutes. In a more preferred embodiment, the steaming time is about 10 minutes.

As described hereinbefore, the non-nut plant material is present in the spreadable food product as a flour. In certain preferred embodiments, the flour is substantially-free of peanut allergen. Preparation of the flour is, inter alia, important for production of a nut-free spreadable food product with a smooth texture. Typically, although not exclusively, the flour is prepared by grinding the plant material, and in particular the non-nut plant material, followed by sieving the ground plant material through a screen with a defined size to produce a flour with a constant average particle size.

Preferably, the flour has an average particle size of less than about 100 μm

More preferably, the flour has an average particle size between 40 μm and 85 μm.

Even more preferably, the flour has an average particle size of about 50 μm.

By “substantially-free” in the context of peanut allergen is meant a level of peanut allergen that will not cause an allergic reaction upon consumption of the spreadable food product. It will be appreciated that in those contexts where flour is derived from a non-nut plant material that is considered allergen-free such as rice, “substantially-free” may refer to peanut allergen or an alternative food allergen, but is not limited thereto.

Typically, although not exclusively, the non-nut plant material is a seed and as such, is composed of an embryo and a coat. In an alternative preferred embodiment of the invention, the coat is removed from the seed, and in particular the mungbean, prior to the roasting or a steaming step. According to this embodiment, the coat comprises no greater than 1% w/w of the final content of the spreadable food product.

In a preferred embodiment, the mungbean is germinated prior to processing, although a person of skill in the art will appreciate that many non-nut plant materials and in particular legumes, may undergo germination. Inclusion of a germination step increases the nutritional value of the spreadable food-product. Germination is a complex process that results in a number of significant biochemical changes in the seed. Generally, the conditions that support germination are adequate moisture, warm temperatures, and usually little or no light. Most seeds germinate best in the dark, although some require light. Germination can be induced by exposure of the non-nut plant material to moisture under controlled conditions. Preferably, germination is performed under light-deprived conditions at room temperature.

The duration of germination can vary. Preferably, germination is performed for between 12 to 48 hours. More preferably, germination is allowed to proceed for 24 hours.

It can be readily appreciated that the roasted or steamed flour substantially free of peanut allergen produced according to the processes of the present invention can form the foundation of a tasty and nutritional spreadable food product. It is contemplated that the composition of the spreadable food product of the present invention can be adapted to suit various taste requirements. In one embodiment, the spreadable food product of the present invention is a nut-free peanut butter substitute. In another embodiment, the spreadable food product of the present invention is a chocolate-flavoured nut-free spread.

A number of criteria must be considered when formulating a spreadable food product that fulfils the expectations of consumers. For instance, consumers desire a product with good spreadability that has a pleasant feel on the palate. Therefore, consistency and texture of the final product are equally as important as taste. As such, the composition must be a fine balance between the individual components of the spreadable food product.

The roasted or steamed flour substantially-free of peanut allergen imparts the nut-like flavour to the spread and as such, is a major component.

Preferably, the roasted or steamed flour is added to a final concentration of 30-65% w/w.

Edible oil is a substantial component of a spreadable food product composition. The oil component adds not only to the flavour but also to the spreadability of the final product. However, excessive oil content is not desirable from a dietary perspective. As such, a balance must be met between each consideration. The spreadable food product of the present invention is suited to any type of edible oil. It can be contemplated that animal or plant-derived oil can be incorporated into the composition. In a preferred form, the oil has relatively low levels of cholesterol, trans- and saturated-fats. Therefore, the invention is particularly suited to oil derived from plants. Non-limiting examples include oil derived from sources such as vegetable, sunflower, soybean, olive and canola.

Preferably, the oil is canola oil added to a final concentration between 18 and 40% w/w.

In order to provide a sweet flavour to the spreadable food product, a sweetening agent is included in the composition. Suitably, a sugar is used as the sweetening agent. A number of sugars are suitable for use. By way of example only, sugars contemplated by the invention include, but are not limited to sucrose, glucose, dextrose, fructose and invert. It is further contemplated that the sugar may be added as either a solid or liquid or indeed a combination thereof. It is also contemplated that a synthetic analogue of a sweetening agent may be used in the present invention.

Preferably, the sugar is a solid.

More preferably, the sugar is solid sucrose.

Even more preferably, the solid sucrose has an average particle size below 90 μm.

Preferably, the sugar is added to a final concentration of between 0.05 and 15% w/w.

During production of a spreadable food product of the present invention, it is essential that the flour and oil components remain in a homogenous state after blending. Additives such as emulsifiers and stabilisers perform this function. Preferably, the additive is an emulsifier.

The emulsifier may be either natural or synthetic. Non-limiting examples of a suitable emulsifiers are lecithins, mono- and di-glycerides of fatty acids, esters of monoglycerides. Preferably, the emulsifier is polyglcerol added to a final concentration of between 2 and 3.5% w/w.

The presence of salt in processed food products may provide any one of a number of functions including, but not limited to, a flavour enhancer, a sweetener, a preservative and a flavour balancing agent. Because salt affects the way other tastes are perceived, it often can be added to food products to balance the flavour. Moreover, salt can increase and decrease sweetness, with the end result being both product- and level-dependent. Typically, although not exclusively, sodium chloride is the salt of choice.

Preferably, the salt is added to a final concentration of between 0.2 and 0.5% w/w.

In a preferred embodiment, the salt is added as a solid with an average particle size below about 100 μm.

More preferably, the salt has an average particle size between 40 μm and 90 μm.

In one embodiment of the invention, the spreadable food product of the present invention is a nut-free peanut butter like spread. In the preferred form of this embodiment, the composition comprises 56.75% w/w mungbean flour, 35% w/w canola oil, 5% w/w icing sugar, 0.25% w/w salt, 3% w/w polyglycerol.

In an alternative embodiment of the spreadable food product of the invention, the composition may be adapted to incorporate a chocolate flavour to thereby produce a delicious chocolate nut-free spread.

The chocolate flavour may be added in a variety of ways. By way of example only, both pure cocoa powder and chocolate are suitable. Each component may be added alone or in combination.

It can be appreciated that most types of chocolate can be used, the choice of which being dependent upon the desired outcome. Chocolate is grouped by the amount of cocoa solids in the final product. That is, the level of content of cocoa solids increases through the progression from white to milk to dark chocolate. Traditionally, dark chocolate is used in cooking applications because of its higher cocoa solids content. Non-limiting examples of suitable types of dark chocolate include sweet, semi-sweet, bittersweet and unsweetened. Preferably, the chocolate is a sweet dark chocolate.

Preferably, the chocolate flavouring is added to a final concentration of between 10 and 35% w/w.

In another preferred embodiment, the chocolate flavouring is a combination of 10% chocolate and 10% cocoa powder.

According to the preferred form of this embodiment, the spreadable food product composition comprises 33% w/w mungbean flour, 25% w/w canola oil, 13% w/w icing sugar, 0.25% w/w salt, 3.25% w/w polyglycerol and 27.52% w/w sweet dark chocolate.

So that the present invention may be more readily understood and put into practical effect, the skilled person is referred to the following non-limiting examples.

### EXAMPLES

### Example 1

Nut free spread was prepared having the following compositions, where the amounts are indicated as a weight percentage based on the total weight of the composition:

| | A | B | C |
|---|---|---|---|
| Mungbean* | 54.85 | 56.75 | 60 |
| Canola oil | 37 | 35 | 31.75 |
| Sugar | 4.9 | 5 | 5 |
| Salt | 0.25 | 0.25 | 0.25 |
| Additive | 3 | 3 | 3 |

*Where the mung bean has been treated with any of the above processes.

For this example the preferred treatment would be mung bean flour reduced to a particle size of less than 85 microns and roasted at 200° C. for 4 minutes. The roasted mung bean flour is then blended with the remainder of the ingredients.

The adjustment of the ratio of mungbean and canola in the example modifies the spreadability of the product and flavour. The higher mungbean addition of 60, provided the firmest texture and most intense nutty flavour.

### Example 2

Nut free chocolate spread was prepared having the following compositions, where the amounts are indicated as a weight percentage based on the total weight of the composition:

| | A | B | C |
|---|---|---|---|
| Mungbean* | 30.45 | 33 | 40.61 |
| Chocolate | 41.2 | 27.52 | 24.27 |
| Canola oil | 22.23 | 23 | 20 |
| Sugar | 2.74 | 13 | 11.62 |
| Salt | 0.14 | 0.25 | 0.25 |
| Additive | 3.25 | 3.25 | 3.25 |

*Where the mung bean has been treated with any of the above processes.

For this example the preferred treatment would be the steaming of mung bean flour or broken dehulled mung beans at 100° C. for 35 minutes. The steamed mung bean is then blended with the other ingredients and at the completion of processing will have a particle size of less than 85 microns but preferably less than 50 microns.

The ratio of chocolate has a significant impact on the texture of the product. Increasing the ratio of chocolate increases the firmness of the product which reduces the ability to spread the product. The chocolate is temperature sensitive and at low temperatures the highest ratio of chocolate led to a solid product.

### Example 3

An alternative nut free chocolate spread will be prepared with the use of rice having the following compositions, where the amounts are indicated as a weight percentage based on the total weight of the composition:

| | A | B | C |
|---|---|---|---|
| Rice* | 25.45 | 28 | 30.61 |
| Chocolate | 41.2 | 27.52 | 24.27 |
| Canola oil | 22.23 | 23 | 20 |
| Sugar | 2.74 | 13 | 11.62 |
| Salt | 0.14 | 0.25 | 0.25 |
| Additive | 3.25 | 3.25 | 3.25 |
| Rice flour | 5.00 | 5.00 | 10.00 |

*Whole or broken rice will be steamed for between 6 to 15 minutes depending on the particle size of the rice, at the completion of the steaming the rice starch is considered gelatinised. The steamed rice will then blended with the remainder of the ingredients with the particle size of the rice reduced to less than 50 microns.

The ratio of chocolate has a significant impact on the texture of the product. Increasing the ratio of chocolate increases the firmness of the product which reduces the ability to spread the product. The chocolate is temperature sensitive and at low temperatures the highest ratio of chocolate will lead to a solid product. Rice flour with a particle size less than 85 microns, but more preferably less than 50 microns will also blended with the spread. The proportion of rice flour will then be adjusted to control the rate of digestibility of the spread product where higher proportions of rice flour slow the digestion of the spread.

### Example 4

TABLE 1
Objective measurement of roasted mungbean flour
Minolta colour of roasted mungbean powder (85 micron) at 200 C. 3 reps

| | b* | L* | a* |
|---|---|---|---|
| Raw | 19.89 | 96.04 | −2.09 |
| 4.5 min | 21.84 | 92.01 | 0.62 |
| 5 min | 22.95 | 90.1 | 1.85 |
| 5.25 min | 22.77 | 82.94 | 2.75 |
| 6 min | 24.9 | 26.3 | 3.76 |

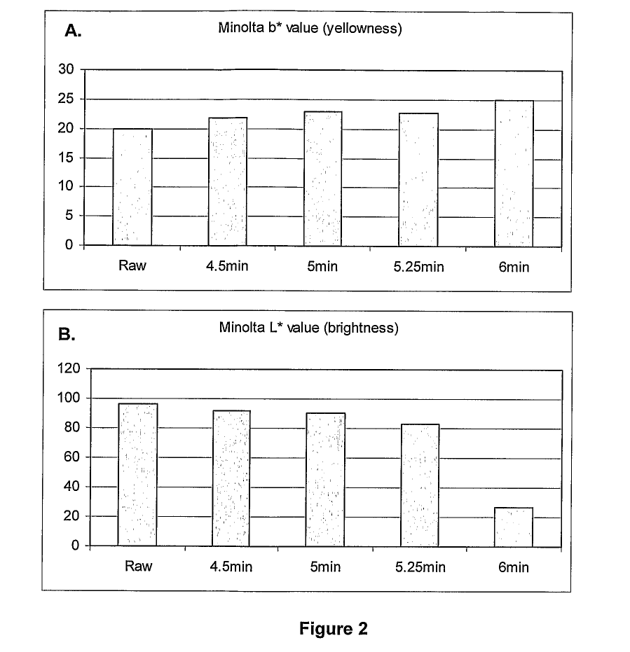

Table 1 and FIG. 2 demonstrated that the colour of the flour reflects the degree of roasting. With increasing roasting time the flour becomes darker. There is a threshold at which the flour takes on a burnt flavour rather than further development of the peanut like flavour. After six minutes of roasting the flour has strong burnt flavours which are considered undesirable.

Roasting of flours at high temperature is used to developed the roasted flavour that is similar to peanut. However another consequence of roasting is the development of burnt flavours and darkening of the flour colour. The relationship between flour darkening and the development of burnt flavours is very strong. The aim of the roasting is to maximize roasted flavour without developing a burnt flavour. Monitoring of flour colour has been used to control the roasting treatment. In the following FIGS. 2a and 2b) the change in flour colour during the roasting of mung bean flour has been measured with a Minolta Chroma Meter. In FIG. 2a the yellowness (b*) of the flour has been measured. It can be observed that flour yellowness increased with roasting time at 200° C. In FIG. 2b the brightness (L*) of the roasted mungbean flour has been measured. As the roasting time at 200° C. increases the brightness of the flour decreases. At 5.25 minutes the flour colour reaches a threshold and flour brightness rapidly deteriorates. It is important to stop the roasting process before this point is reached.

### Example 5

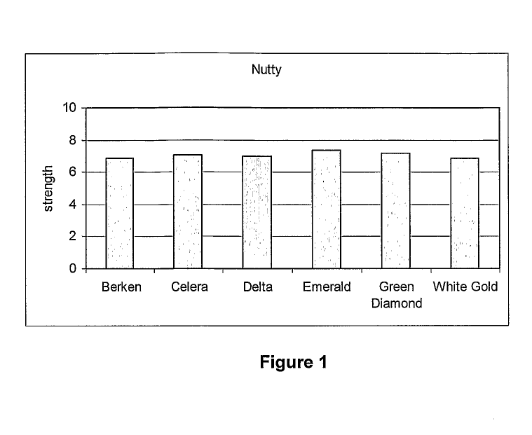

FIG. 1 demonstrates that Mung bean varieties were found to demonstrate small differences in flavour when heat treated. The strongest nut flavour and therefore the most desirable mung bean for the use in this application was the variety Emerald. However all mungbean varieties tested produced acceptable flavour intensity expressed in FIG. 1 as “strength”.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, patent and scientific literature referred to herein is incorporated herein by reference.

1. A process of producing a spreadable food product, said process including the steps of:
(a) grinding a non-nut plant material to produce a flour with a mean particle size of less than about 100 μm; and
(b) subjecting said flour with a mean particle size of less than about 100 μm to an elevated temperature.

2. The process of claim 1, wherein step (a) includes a sifting treatment.

3. The process of claim 1, wherein the non-nut plant material is selected from the group consisting of a legume and a cereal grain.

4. The process of claim 3, wherein the cereal grain is rice.

5. The process of claim 3, wherein the legume is selected from the group consisting of a bean, a broad bean, a pea and a lentil.

6. The process of claim 5, wherein the pea is a chickpea.

7. The process of claim 5, wherein the bean is a mungbean.

8. The process of claim 7, wherein the mungbean is a variety selected from the group consisting of Berken, Celera, Delta, Emerald, Green Diamond and White Gold.

9. The process of claim 8, wherein the variety is Emerald.

10. The process of claim 3, wherein the legume has undergone a germination step.

11. The process of claim 10, wherein the germination step is performed for a period between 12 and 48 hours.

12. The process of claim 11, wherein germination step is performed for about 24 hours.

13. The process of claim 1, wherein the flour has a mean particle size in a range between 40 μm and 85 μm.

14. The process of claim 12, wherein the flour has a mean particle size of about 50 μm.

15. The process of claim 1, wherein the flour with a mean particle size of less than about 100 μm is subjected to an elevated temperature by treatment selected from the group consisting of a roasting or a steaming.

16. The process of claim 15, wherein the flour with a mean particle size of less than about 100 μm is subjected to an elevated temperature by roasting.

17. The process of claim 16, wherein the elevated temperature by roasting is in a range between 180° C. and 250° C.

18. The process of claim 17, wherein the elevated temperature by roasting is about 200° C.

19. The process of claim 16, wherein roasting is for a period between 3 and 6 minutes.

20. The process of claim 19, wherein roasting is for a period of between 3.5 and 4 minutes.

21. The process of claim 15, wherein the flour with a mean particle size of less than about 100 μm is subjected to an elevated temperature by steaming.

22. The process of claim 21, wherein the elevated temperature by steaming is between 80° C. and 150° C.

23. The process of claim 22, wherein the elevated temperature by steaming is about 100° C.

24. The process of claim 21, wherein steaming is for a period between 20 and 45 minutes.

25. The process of claim 24, wherein steaming is for about 35 minutes.

26. A process of producing a spreadable food product, said process including the steps of:
(a) subjecting a non-nut plant material to an elevated temperature; and
(b) grinding said non-nut plant material to produce a flour with a mean particle size of less than about 100 μm.

27. The process of claim 26, wherein step (b) includes a sifting treatment.

28. The process of claim 26, wherein the non-nut plant material is selected from the group consisting of a legume and a cereal grain.

29. The process of claim 28, wherein the cereal grain is rice.

30. The process of claim 28, wherein the legume is selected from the group consisting of a bean, a broad bean, a pea and a lentil.

31. The process of claim 30, wherein the pea is a chickpea.

32. The process of claim 30, wherein the bean is a mungbean.

33. The process of claim 32, wherein the mungbean is a variety selected from the group consisting of Berken, Celera, Delta, Emerald, Green Diamond and White Gold.

34. The process of claim 33, wherein the variety is Emerald.

35. The process of claim 28, wherein the legume has undergone a germination step.

36. The process of claim 35, wherein the germination step is performed for a period between 12 and 48 hours.

37. The process of claim 36, wherein the germination step is performed for a period of about 24 hours.

38. The process of claim 26, wherein the non-nut plant material is subjected to an elevated temperature by treatment selected from the group consisting of a roasting or a steaming.

39. The process of claim 38, wherein the non-nut plant material is subjected to an elevated temperature by roasting.

40. The process of claim 39, wherein the elevated temperature by roasting is in a range between 180° C. and 230° C.

41. The process of claim 40, wherein the elevated temperature by roasting is about 200° C.

42. The process of claim 39, wherein the roasting is for a period between 3 and 6 minutes.

43. The process of claim 42, wherein the roasting is for a period between 3.5 and 4 minutes.

44. The process of claim 38, wherein the non-nut plant material is subjected to an elevated temperature by steaming.

45. The process of claim 44, wherein the elevated temperature by steaming is between 80° C. and 150° C.

46. The process of claim 45, wherein the elevated temperature by steaming is about 100° C.

47. The process of claim 44, wherein the steaming is for a period between 20 and 45 minutes.

48. The process of claim 47, wherein the steaming is for about 35 minutes.

49. The process of claim 26, wherein the flour has a mean particle size of between 40 μm and 85 μm.

50. The process of claim 49, wherein the flour has a mean particle size of about 50 μm.

51. A process for producing a spreadable food product, said process including the steps of:
(a) steaming a dehulled non-nut plant material; and
(b) grinding said steamed dehulled non-nut plant material to form a flour with a mean particle size of less than about 100 μm.

52. The process of claim 51, wherein step (a) is performed at a temperature between 80° C. and 150° C.

53. The process of claim 52, wherein the temperature is about 100° C.

54. The process of claim 51, wherein step (b) is performed at a temperature of at least 45° C.

55. The process of claim 54, wherein the temperature is at least 60° C.

56. The process of claim 51, wherein step (b) includes a sifting step.

57. The process of claim 51, wherein the dehulled non-nut plant material is selected from the group consisting of a legume and a cereal grain.

58. The process of claim 57, wherein the cereal grain is rice.

59. The process of claim 57, wherein the legume is selected from the group consisting of a bean, a broad bean, a pea and a lentil.

60. The process of claim 59, wherein the pea is a chickpea.

61. The process of claim 59, wherein the bean is in a mungbean.

62. The process of claim 61, wherein the mungbean is a variety selected from the group consisting of Berken, Celera, Delta, Emerald, Green Diamond and White Gold.

63. The process of claim 62, wherein the variety is Emerald.

64. The process of claim 51, wherein the flour has a mean particle size of between 40 μm and 85 μm.

65. The process of claim 51, wherein the flour has a mean particle size of about 50 μm.

66. A spreadable food product produced according to the process of any one of claim 1, claim 26 or claim 51.

67. A spreadable food product, wherein said spreadable food product comprises a non-nut plant material flour having a mean particle size of less than about 100 μm, an edible oil and a sweetening agent.

68. The spreadable food product of claim 67, wherein the edible oil is selected from the group consisting of vegetable oil and canola oil.

69. The spreadable food product of claim 68, wherein the edible oil is canola oil at a final concentration of between 18-35% w/w.

70. The spreadable food product of claim 67, wherein the sweetening agent is a sugar selected from the group consisting of a solid sugar or a liquid sugar.

71. The spreadable food product of claim 70, wherein the sugar is a solid sugar with a mean particle size below 90 μm.

72. The spreadable food product as claimed in any one of claims 70 to 71, wherein the sweetening agent is at a final concentration of between 0.1 and 15% w/w.

73. The spreadable food product of claim 67, wherein said spreadable food product further comprises an emulsifier.

74. The spreadable food product of claim 73, wherein the emulsifier is polyglycerol at a final concentration between 3 and 3.5% w/w.

75. The spreadable food product of claim 74, wherein polyglycerol is at a final concentration of about 3% w/w.

76. The spreadable food product of claim 67, wherein said spreadable food product further comprises a salt.

77. The spreadable food product of claim 76, wherein the salt is at a final concentration between 0.2 and 0.5% w/w.

78. The spreadable food product of any one of claims 67 to 77, wherein said spreadable food product comprises the flour with a mean particle size of less than about 100 μm in a range at a final concentration of between 50 and 65% w/w.

79. The spreadable food product of claim 78, wherein the final concentration of the flour with a mean particle size of less than about 100 μm is about 56% w/w.

80. The spreadable food product of any one of claims 67 to 77, wherein said spreadable food product further comprises a chocolate flavouring.

81. The spreadable food product of claim 80, wherein the chocolate flavouring is selected from the group consisting of a milk chocolate and a dark chocolate.

82. The spreadable food product of claim 81, wherein the dark chocolate is at a final concentration of between 10 and 35% w/w.

83. The spreadable food product of claim 82, wherein the dark chocolate is at a final concentration of about 27% w/w.

84. The spreadable food product of any one of claims 80 to 83, wherein the spreadable food product comprises the flour with a mean particle size of less than 100 μm is at a final concentration of between 30 and 40% w/w.

85. The spreadable food product of claim 84, wherein the flour with a mean particle size of less than 100 μm is at a final concentration of about 33% w/w.
